(19) United States
(12) Patent Application Publication
(10) Pub. No.: US 2013/0073578 A1
(43) Pub. Date: Mar. 21, 2013

(54) Processing Audio-Video Data To Produce Metadata

(71) Applicants: Denise Bland, Fetcham (GB); Sam Davies, Earlsfield (GB); Nicholas Pinks, Wimbledon (GB)

(72) Inventors: Denise Bland, Fetcham (GB); Sam Davies, Earlsfield (GB); Nicholas Pinks, Wimbledon (GB)

(73) Assignee: BRITISH BROADCASTING CORPORATION, London (UK)

(21) Appl. No.: 13/699,803

(22) PCT Filed: May 27, 2011
(86) PCT No.: PCT/GB2011/000820

§ 371 Date: Nov. 26, 2012

(30) Foreign Application Priority Data
May 28, 2010 (GB) GB1009066.0

(51) Int. Cl. G06F 17/30

(52) U.S. Cl. 707/758; 707/E17.009; 707/E17.014

(57) ABSTRACT

A system for processing audio-video data to produce metadata, has an input for receiving audio video data. A characteristic extraction unit is arranged to extract n multiple distinct characteristics from the received audio-video data. A data comparison unit is arranged to compare the n multiple distinct characteristics with data extracted from example audio-video data by comparing in n dimensional space to produce a value for each of f features of the audio-video data where f<n. A multi-dimensional metadata unit is arranged to receive the values for each feature and to produce a complex continuous metadata value of M dimensions for the audio-video data where M<f.

### BACKGROUND OF THE INVENTION

This invention relates to a system and method for processing audio-video data to produce complex metadata.

Audio-video content, such as television programmes, comprises video frames and an accompanying sound track which may be stored in any of a wide variety of coding formats, such as MPEG-2. The audio and video data may be multiplexed and stored together or stored separately. In either case, a given television programme or portion of a television programme may be considered a set of audio-video data or content (AV content for short).

It is convenient to store metadata related to AV content to assist in the storage and retrieval of AV content from databases for use with guides such as electronic program guides (EPG). Such metadata may be represented graphically for user selection, or may be used by systems for processing the AV content. Example metadata includes the contents title, textural description and genre.

Metadata is often manually created at the point of creating or storing AV content. However, such metadata may not exist for existing archives of AV content.

### SUMMARY OF THE INVENTION

We have appreciated the need to produce metadata from audio-video content using techniques which are scalable to produce metadata for AV content archives (which may be very large) in such a manner that the metadata may then be easily manipulated by subsequent processes or user interaction. In broad terms, the invention provides a system and method for producing a complex metadata value of M dimensions for audio-video data. To produce the M dimensional metadata, the invention compares multiple features with corresponding data extracted from example audio-video data. In this way, a variety of feature analysis techniques may be used and the result reduced to an M dimensional value.

In contrast to prior techniques, the present invention does not need to allocate simplistic textual metadata values, such as genre (thriller, comedy, sit-com and so on). Instead, the metadata value may be considered to have variable components along each of the M dimensions which can represent a variety of attributes. The metadata value is variable or continuous in the sense that it has at least a sufficiently large number of possible values between a maximum and minimum that it appears continuous when represented graphically. Such an approach allows more subtle subsequent processing of the AV content with reference to the specific values in each dimension.

An embodiment of the invention also allows more subtle representation of the metadata to a user, for example, as a two-dimensional or three-dimensional chart showing the nature of the AV content by a position along each of the two or three dimensions. The dimensions may represent a “mood” of the audio-video data such as happy/sad, exciting/calm and so on. Such a representation then allows a user to select content based on a specific value of the complex metadata or similar content based on the complex metadata value, rather than authored metadata, such as genre.

### BRIEF DESCRIPTION OF THE DRAWINGS

The invention will now be described in more detail by way of example with reference to the drawings, in which:

FIG. 1: is a diagram of the main functional components of a system embodying the invention;

FIG. 2: is a diagram showing audio amplitude against time for a sample of audio related to studio laughter;

FIG. 3: shows a two-dimensional representation of two-dimensional complex metadata values;

FIG. 4: shows a three-dimensional representation of three-dimensional complex metadata values; and

FIG. 5: shows a further three-dimensional representation of three-dimensional complex metadata values.

### DETAILED DESCRIPTION OF THE PREFERRED EMBODIMENTS

The invention may be embodied in a method and system for processing audio-video data (which may also be referred to as AV content) to produce metadata that is multi-dimensional in the sense that the metadata may have a value in each of M attributes and so may be represented on an M dimensional chart. The M dimensional metadata may be used in any subsequent form of processing, for example AV content having a high value in a particular metadata dimension may be processed and stored in a certain way. Preferably, though, the M dimensional data can be represented by a graphical user interface to allow a user to select AV content based on the position of the multi-dimensional metadata value on a chart. Specifically, in the embodiment the multi-dimensional metadata represents a “mood” of the AV content, such as happy/sad, exciting/calm or the like.

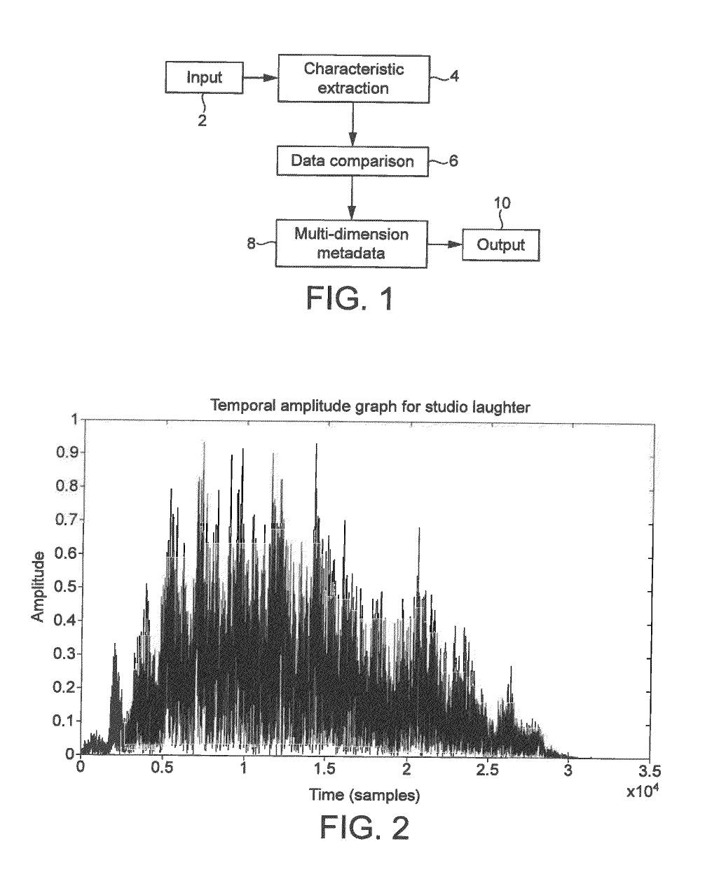

A system embodying the invention is shown in FIG. 1. The system may be implemented as dedicated hardware or as a process within a larger system. The system comprises an input 2 for receiving AV content, for example, retrieved from an archive database. A characteristics extraction engine 4 which analyses the audio and/or video data to produce values for a number of different characteristics, such as audio frequency, audio spectrum, video shot changes, video luminance values and so on. A data comparison unit 6 receives the multiple characteristics for the content and compares the multiple characteristics to characteristics of other known content to produce a value for each characteristic. Such characteristic values, having been produced by comparison to known AV data, can thereby represent features such as the probability of laughter, relative rate of shot changes (high or low) existence of comparatively high/low scenes with faces directed towards the camera. A multi-dimensional metadata engine 8 then receives the multiple feature values and reduces these feature values to a complex metadata value of M dimensions which may then be produced at an output 10 for further processing or for rendering on a graphical display.

The extracted features may represent aspects such as laughter, gun shots, explosions, car tyre screeching, speech rates, motion, cuts, faces, luminance and cognitive features. The data comparison and multi-dimensional metadata units generate a complex metadata “mood” value from the extracted features. The complex mood value has happy, sad, exciting and cairn components.

The audio features are laughter, gun shots, explosions, car tyre screeching and speech rates. The video features are motion, cuts, luminance, faces and cognitive values.

The functional units shown in FIG. 1 will now be described in greater detail.

### Input

The input 2 receives the AV content to be analysed. Whilst this may potentially come from a live AV feed, this preferably retrieves AV content from some form of archive for analysis, adding of the metadata and subsequent storing. The processing of AV content to produce metadata does not typically require full fidelity of the data and so the input may reduce the data, for example, reducing the video data to lower resolution and to grey scale and transcoding to a format appropriate for the feature extraction engine, in this way, the input may receive AV content in a wide variety of different formats and render the data in a form appropriate for analysis.

### Characteristic Extraction

The characteristic extraction engine 4 provides a process by which the audio data and video data may be analysed and characteristics discussed above extracted. For audio data, the data itself is typically time coded and may be analysed at a defined sampling rate discussed later. The video data is typically frame by frame data and so may be analysed frame by frame, as groups of frames or by sampling frames at intervals. The audio features will now be described followed by the video features.

### Audio

The low level audio features or characteristics that are identified include torment frequencies, power spectral density, bark filtered root mean square amplitudes, spectral centroid and short time frequency estimation. These low level characteristics may then be compared to known data to produce a value for each feature.

### Formant Frequencies.

These frequencies are the fundamental frequencies that make up human vocalisation. As laughter is produced by activation of the human vocal tract, Torments frequencies are a key factor in this. A discussion of formant frequencies in laughter may be found in Szameitat at al “interdisciplinary Workshop on the Phonetics of Laughter”, Saarbrucken, 4-5 Aug. 2007 found the F1 frequencies to be much higher than for normal speech patterns. Thus, they are a key feature for identification. Formant frequencies were estimated by using Linear Prediction Coefficients. In this, the first 5 formants were used. Experimental evidence showed that this gave the best results and study of further formants was superfluous. These first five formants were used as feature vectors. If the algorithm could not estimate five fundamental frequencies, then this window was given a special value indicating no match.

### Power Spectral Density

This is a measure of amplitude for different component frequencies. For this, Welch's Method (a known approach to estimate power vs frequency) was used for estimating the signals power as a function of frequency. This gave a power spectrum, from which the mean, standard deviation and auto covariance were calculated.

### Bark Filtered Root Mean Squared Amplitudes

As a follow on from looking at the power/amplitude in the whole signal using Welch's Method based on work contained in Welch, P. “The Use of Fast Fourier Transforms for the Estimation of Power Spectra: A Method Based on time Averaging over Short Modified periodgrams”, IEEE Transactions of Audio and Electroacoustics, Vol 15, pp 70-73 (Welch 1967), the it signal was put through a Bark Scale Filter bank. This filtering corresponds to the critical bands of human hearing of the human ear, following Bark Scales. Once the signal was filtered into 24 bands, the Root Mean Squared amplitudes were calculated for each filter bank, and used as a feature vector.

### Spectral Centroid.

The spectral centroid is used to determine where the dominant centre of the frequency spectrum is. A Fourier Transform of the signal is taken, and the amplitudes of the component frequencies are used to calculate the weighted mean. This weighted mean, along with the standard deviation and auto covariance were used as three feature values.

### Short Time Frequency Estimation.

Each windowed sample is split into a sub window each 2048 samples in length. From this autocorrelation was used to estimate the main frequency of this sub-window. The average frequency of all these sub-windows, the standard deviation and auto covariance were used as the feature vectors.

The low level features or characteristics described above give certain information about the audio-video content, but in themselves are difficult to interpret, either by subsequent processes or by a video representation. Accordingly, the low level features or characteristics are combined by data comparison as will now be described.

### Data Comparison

A low level feature, such as torment frequencies, in itself may not provide a sufficiently accurate indication of the presence of a given feature, such as laughter, gun shots, tyre screeches and so on. However, by combining multiple low level features/characteristics and comparing such characteristics against known data, the likely presence of features within the audio content may be determined. The main example is laughter estimation.

### Laughter Estimation

A laughter value is produced from low level audio characteristics in the data comparison engine. The audio window length in samples is half the sampling frequency. Thus, if the sampling frequency is 44.1 kHz, the window will be 22.05 k samples long, or 50 ms. There was a 0.2 sampling frequency overlap between windows. Once the characteristics are calculated, they are compared to known data (training data) using a variance on N-Dimensional Euclidean Distance. From the above characteristics extraction, the following characteristics are extracted;

| | |
|---|---|
| Formant Frequencies | Formants 1-5 |
| Power Spectral Density | Mean |
| | Standard Deviation |
| | Auto covariance |
| Bark Filtered RMS Amplitudes | RMS amplitudes for Bark filter |
| | bands 1-23 |
| Spectral Centroid | Mean |
| | Standard Deviation |
| | Auto covariance |
| Short Time Frequency Estimation | Mean |
| | Standard Deviation |
| | Auto covariance |

These 37 characteristics are then loaded into a 37 dimension characteristics space, and their distances calculated using Euclidean distance as follows;

$$d ( p , q ) = \sqrt{{\sum }_{i = 1}^{n} {( \begin{matrix}{p}_{i} & {q}_{i}\end{matrix} )}^{2}}$$

This process gives the individual laughter content estimation for each windowed sample. However, in order to improve the accuracy of the system, adjacent samples are also used in the calculation, in the temporal domain, studio laughter has a definable temporal structure, the initial build up, full blown laughter followed by a trailing away of the sound, as shown in FIG. 2.

From an analysis of studio laughter from a Sound effect library and laughter from 240 hours of AV material, it was found that the average length of the full blown laughter, excluding the build up and trailing away of the sound was around 50 ms. As can be seen from FIG. 2, there is a clear rise, peak, fall envelope to the amplitude of laughter. Thus, three windows (covering 90 ms being 50 ms in length each with a 20 ms offset) can then be used to calculate the probability p(L) of laughter in window i based upon each windows Euclidean distance from the training data d;

p(Lᵢ)=d(pᵢ₋₁,qᵢ₋₁)+d(pᵢ,qᵢ)+d(pᵢ₊₁,qᵢ₊₁)

where d(pᵢ₋₂,qᵢ₋₁)>d(pᵢ,qᵢ)<d(pᵢ₊₂,qᵢ₊₂) and d(pᵢ,qᵢ)<threshold

Once the probability of laughter is identified, a feature value can be calculated using the temporal dispersal of these identified laughter cups. Even if a sample were found to have a large probability of containing laughter, if it were an isolated incident, then the programme as a whole would be unlikely to be considered as “happy”. Thus, the final probability p(L) is upon the distance d of window i;

$${dt}_{t} = ( T ( p ( {L}_{i} ) ) - T ( p ( {L}_{i - 1} ) ) ) + ( T ( p ( {L}_{i + 1} ) - T ( p ( {L}_{i} ) ) ) \\ p ( {L}_{i} ) = \frac{1}{{e}^{{dt}_{i}}}$$

To assess the algorithms described when the probability of laughter reaches a threshold of 80%, a laughter event was announced and, for checking, this was displayed as an overlaid subtitle on the video file.

### Other Audio Features

Gun shots, explosions and car tyre screeches are all calculated in the same way, although without the use of formant frequencies. Speech rates are calculated using Mel Frequency Capatrum Coefficients and formant frequencies to determine how fast people are speaking on screen. This is then used to ascertain the emotional context with which the words are being spoken. If words are being spoken in rapid succession with greater energy, there is more emotional intensity in the scene than if they are spoken at a lower rate with lower energy.

### Video

The video features may be directly determined from certain characteristics that are identified are as folio s.

### Motion

Motion values are calculated from 32×32 pixel gray scaled version of the AV content. Motion value is produced from the mean difference between the current frame fₖ and the tenth previous frame fₖ₋₁₀.

The motion value

Motion=scale*Σ|fₖ−fₖ₋₁₀|

### Cuts

Cuts values are calculated from 32×32 pixel gray scaled version of the AV content. Cuts value is produced from the threshold product of the mean difference and the inverse of the phase correlation between the current frame fₖ and previous frame fₖ₋₁.

The mean difference is:

md=scale*Σ|fk−fk₋₁|

The phase correlation is:

pc=max(invDFT((DFT(fₖ)*(DFT(_{fx-1})′))/|(DFT(fₖ)*(DFT(fₖ₋₁)′)|)))

The cuts value is:

Cuts=threshold(md*(1−pc))

### Luminance

Luminance values are calculated from 32×32 pixel gray scaled version of the AV content. Luminance value is the summation of the gray scale values:

Luminance=Σfₖ

Change in lighting is the summation of the difference in luminance values. Constant lighting is the number of luminance histogram bins that are above a threshold.

### Face

Face value is the number of full frontal faces and the proportion of the frame covered by faces for each frame. Face detection on the gray scale image of each frame is implemented using a max implementation of OpenCV's face detector from Matlab central. The code implements Viola-Jones adaboosted algorithm for face detection.

### Cognitive

Cognitive features are the output of simulated simple cells and complex coils in the initial feedforward stage of object recognition in the visual cortex. Cognitive features are generated by the ‘FH’ package of the Cortical Network Simulator from Centre for Biological and Computational Learning, MIT.

### Mufti-Dimensional Metadata Engine

The process described so far takes characteristics of audio-video content and produces values for features, as discussed. The feature vanes produced by the process described above may relate to samples of the AV content, such as individual frames, to portions of a programme or to an average for an entire programme. In the case of audio analysis, multiple characteristics are combined together to give a value for features such as laughter. In the case of video data, characteristics such as motion maybe directly assessed to produce a motion feature value. In both cases, the feature values need to be combined to provide a more readily understandable representation of the metadata in the form of a complex metadata value. The metadata value is complex in the sense that it may be represented in M dimensions. A variety of such complex values are possible representing different attributes of the AV content, but the preferred example is a so-called “moods” value indicating how a viewer would perceive the features within the AV content.

An example generated complex “mood” value consists of happy/sad, exciting/calm and factual/fictional components. Each component is a dimension of the complex metadata value.

Happy/Sad HS: The happy/sad mood component is directly proportional to the laughter value.

Exciting/Calm EC: The exciting/calm mood component may be proportional to the cuts value, the motion value, gun shots value, explosions value and car tyre screeches value. For example EC=Cuts*Motion

Factual/Fictional FF: The factual mood component is inversely proportional to speech rate and proportional to the change in lighting, a factor of the face value and a factor of the cognitive value.

The fictional mood component is proportional to speech rate and constant lighting, a factor of the face value and a factor of the cognitive value.

FF=speech rate+lighting+faces+cognitive

### Complex Mood Value

The complex mood value has 3 dimensions: One dimension of the complex mood value is the happy/sad component HS, another dimension is the exciting/calm component EC and a third dimension is the factual/fictional component FF.

Mood=iHS+jEC+kFF

where i, j and k are orthogonal axis

The complex mood value described can be used to identify content of a specific mood and to cluster content of a similar mood by representation on a display.

### Output

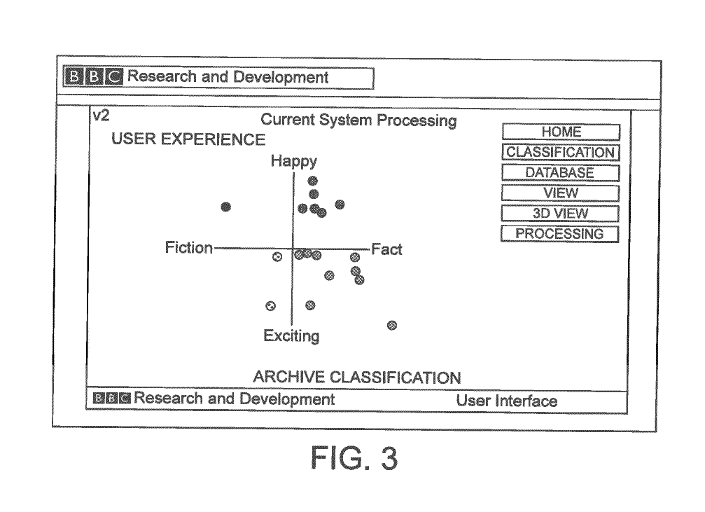

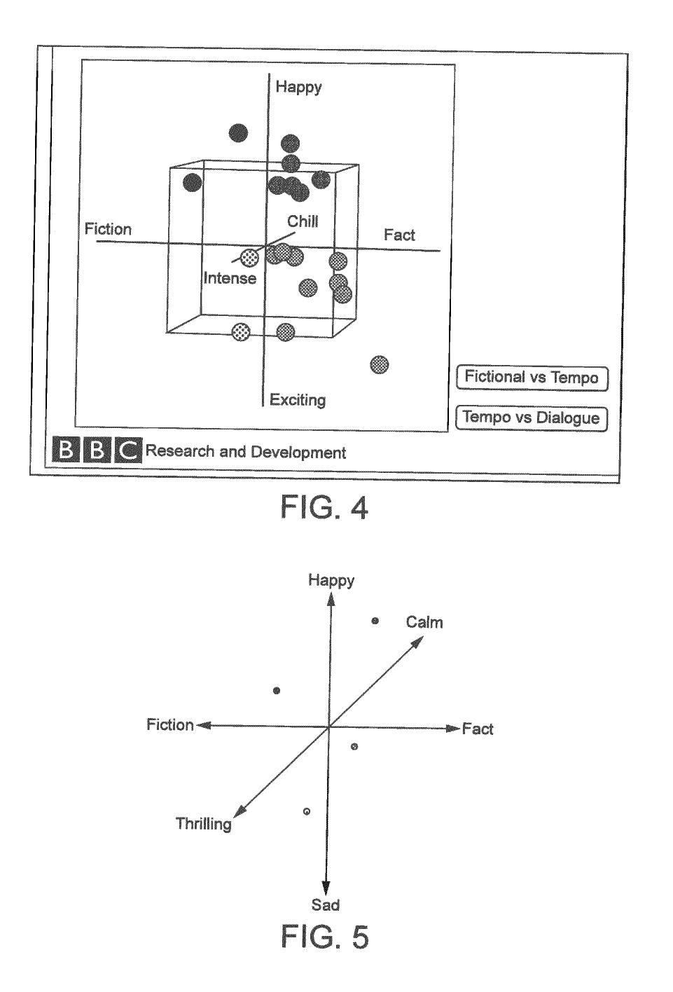

A method for displaying and selecting an AV programme based on the mood metadata value of the programme content is now described with reference to FIGS. 3 and 4. Each programme is tagged with a multi-dimensional analogue mood value with a minimum of two mood components. Each mood component is represented on an axis in a multi-dimensional display. Each programme is represented as a coloured dot on the multi-dimensional display dependent upon their complex mood value. Selection of the programme is by a mouse click on the coloured dot to play the programme. Viewing multiple different programmes represented by their complex mood value on a multi-dimensional display enables direct comparison of programmes using the programme's mood value.

### Two Dimensional Display

An example two dimensional display and content navigation using happy/exciting and factual/fictional mood axes is shown in FIG. 3. When the mouse is moved over a coloured dot representing a programme, the programme information is displayed. When the dot is clicked, the selected TV programme is played.

### Three Dimensional Display

In the 3D display of FIG. 4, the user can click and drag an axis, causing the axis to rotate and show the coloured dots in 3D. When the mouse is moved over a coloured dot representing a programme, the programme information is displayed. When the dot is clicked, the selected TV programme is played.

An example three dimensional display and content navigation using happy/exciting and factual/fictional and intense/chill mood axes is shown in FIG. 4. Another example three dimensional display and content navigation using happy/sad, thrilling/calm and factual/fictional mood axes is shown in FIG. 5.

A number of variations are possible to implementation of the embodiment described. The analysis described for AV content assumes that content is separated into programmes and that the analysis is performed for a programme in its entirety. Equally, the analysis could be performed for chapters or other subsets of programme data. Audio-video data may therefore be a programme, a chapter or any other convenient portion of a larger programme. For example, it would be possible to segment programmes after initial analysis by the characteristic extraction engine into smaller portions at “mood” boundaries. The metadata value is then calculated for each portion of the AV content.

The audio content may be analysed using a rolling window with a window length as described. Alternatively, the analysis could simply be a brief few seconds and may depend upon the rate of change of the content. The video analysis may be for cuts, motion, luminance as described and may be for each individual frame or averaged also over a time window. The preferred approach is that the algorithms described worked through time windows of data sequentially.

The comparison to known data is required for extraction of some features, such as laughter, but other features, such as rate of shot changes, can be determined directly from the AV content being analysed without reference to sample data. At least some characteristics in the audio or video data are compared to know data, as this produces a more accurate result. Such comparison data could be from any source, but is typically from a known recording of the feature to be analysed, but could be from any sound.

The nature of the complex metadata value may describe a “mood” which is a user understandable concept, but could equally describe an abstract concept. Such an approach when represented graphically would still have AV content sharing similar complex metadata values clustered together in an M dimensional representation. This approach may be beneficial for subsequent processing of data, even though the abstract concept may not be readily understandable to a user. For example, AV content with frequent shot changes and large audio dynamic ranges could be grouped for subsequent processing by an appropriate encoding scheme in contrast to data with low shot changes and low dynamic range audio.

1. A system for processing audio-video data to produce metadata, the system comprising:
an input for receiving audio-video data;
a characteristic extraction unit arranged to extract n multiple distinct characteristics from the received audio-video data;
a data comparison unit arranged to compare the n multiple distinct characteristics with data extracted from example audio-video data by comparing in n dimensional space to produce a value for each of f features of the audio-video data where f<n; and
a multi-dimensional metadata unit arranged to receive the values for each feature and to produce a complex continuous metadata value of M dimensions for the audio-video data where M<f.

2. A system according to claim 1 wherein the data comparison unit is arranged to compare n multiple characteristics for audio data, at least one of the n multiple characteristic denoting fundamental formant frequencies.

3. A system according to claim 1, wherein the data comparison unit is arranged to compare the n multiple characteristics by calculating a least mean square distance in each dimension.

4. A system according to claim 1, wherein the data comparison unit is arranged to compare audio data by comparing windowed sample by windowed sample.

5. A system according to claim 4 wherein the window length in samples is half the sampling frequency.

6. A system according to claim 5 wherein adjacent windowed samples are compared to a known time envelope to produce a probability of a match against the known time envelope.

7. A system according to claim 1 wherein the data comparison unit is arranged to compare audio data with data extracted from example audio data, but to derive a value for each feature or video data direct from video data without comparison to example video data.

8. A system according to claim 1 wherein the input is arranged to transcode a received audio-video programme to produce the audio-video data by changing one or more of format, fidelity or data rate.

9. A system according to claim 1 further comprising an output arranged to produce a graphical representation of the M dimensions of the complex metadata value.

10. A system according to claim 9 wherein the system is arranged to produce a graphical output to control a display, to show the complex metadata value for each programme.

11. A system according to claim 10 further comprising a selectable input to allow a user selection of a programme by selecting a complex metadata value from the display.

12. A method for processing audio-video data to produce metadata, the method comprising:
receiving audio-video data;
extracting n multiple distinct characteristics from the received audio-video data;
comparing the n multiple distinct characteristics with data extracted from example audio-video data by comparing in n dimensional space to produce a value for each of f features of the audio-video data where f<n; and
producing, from the values for each feature, a complex continuous metadata value of M dimensions for the audio-video data where M<f.

13. A method according to claim 12 wherein at least one of the n multiple characteristic denoting fundamental formant frequencies.

14. A method according to claim 12 comprising comparing the n multiple characteristics by calculating a least mean square distance in each dimension.

15. A method according to claim 12 comprising comparing audio data by comparing windowed sample by windowed sample.

16. A method according to claim 15 wherein the window length in samples is half the sampling frequency.

17. A method according to claim 15 wherein adjacent windowed samples are compared to a known time envelope to produce a probability of a match against the known time envelope.

18. A method according to claim 12 comprising comparing audio data with data extracted from example audio data, but deriving a value for each feature of video data direct from video data without comparison to example video data.

19. A method according to claim 12 comprising transcoding a received audio-video programme to produce the audio-video data by changing one or more of format, fidelity or data rate.

20. A method according to claim 12, comprising producing a graphical representation of the M dimensions of the complex metadata value.

21. A method according to claim 20 comprising controlling a display, to show the complex metadata value for each programme.

22. A method according to claim 21 further comprising providing a selectable input to allow a user selection of a programme by selecting a complex metadata value from the display.
